(19) United States
(12) Patent Application Publication
(10) Pub. No.: US 2026/0001010 A1
(43) Pub. Date: Jan. 1, 2026

(54) A PURIFICATION RECEPTACLE

(71) Applicant: ASTREA UK SERVICES LIMITED, Cambridgeshire (GB)

(72) Inventor: Adam PINNOCK, Cambridgeshire (GB)

(21) Appl. No.: 18/878,445

(22) PCT Filed: Jun. 23, 2023
(86) PCT No.: PCT/GB2023/051656

§ 371 Date: Dec. 23, 2024

(30) Foreign Application Priority Data
Jun. 24, 2022 (GB) 2209284.5

(51) Int. Cl. B01D 15/22; G01N 30/60

(52) U.S. Cl. CPC B01D 15/22; G01N 30/603

(57) ABSTRACT

A purification receptacle for the chromatographic purification of a liquid. The purification receptacle comprises a seat and a chromatographic media assembly including a chromatographic membrane to which target components contained in a liquid supplied to the receptacle and which passes through the chromatographic membrane bind, and a retaining member configured to compress the chromatographic membrane against the seat. Also disclosed is a chromatographic purification system, a method of separating target components from a liquid sample containing target and non-target components prior to purifying and eluting steps in a chromatographic system, and a chromatographic purification method to isolate a specific target component from a sample liquid.

The present invention relates to a purification receptacle for the chromatographic purification of one or more target components such as molecules, cells, viruses, etc. suspended or contained in a liquid. The invention also relates to a chromatographic purification system, to a chromatographic purification method of separating target components from a liquid sample containing target and non-target components and to a chromatographic purification method of binding and eluting of the target components in a centrifugal chromatographic system and/or a pumped chromatography system.

Chromatography is a purification technique that separates target and non-target components such as chemical or biological compounds contained in a liquid. Chromatography relies on a chromatographic media or adsorbent that adsorbs certain components. Chromatographic media may take different forms such as particles, beads, fibres, felts, monoliths, or membranes. The liquid containing one or more target components is supplied into a receptacle, e.g., a column, containing chromatography media. The amount of liquid supplied depends on the size of the receptacle and the application. At small scale, normally a relatively small amount of liquid is supplied, and at higher scale, a larger quantity of liquid is supplied. Such discrete quantity of liquid can be referred to as a “sample” when provided in a batch or non-continuous manner. Target components bind to the adsorbent when the liquid flows through the chromatography media in an initial separation step. Once the liquid has passed through the chromatography media and non-bound impurities are flushed away, the specific target components bound to the chromatography media can be further purified by supplying a wash buffer through the chromatography media to remove any bound impurities. Subsequently, at least one specific target component can be removed from the chromatographic media with a suitable elution solution which may be a buffer, a solvent or an aqueous co-solvent mixture optionally containing a buffer.

With known chromatographic purification processes, the binding capacity for the target component is often low, coupled with a low processing throughput of the sample leading to extended processing time.

The existing processes have been improved by providing novel chromatographic membranes that have significantly more binding surface area than other known membranes. For example, membranes made from nanofibers (such as cellulose nanofibers) increase the binding capacity by providing considerably more binding surface area than other known materials and so are better suited to use, for example, in the capture of lentiviral vectors (LVV) where a high recovery and flow rate is essential. One such material, developed by the instant applicant, is known as AstreAdept®, a reinforced cellulosic nanofibre material, which makes the surface area highly accessible to viral vectors, cells and other biologically sourced compounds and enables significantly faster flow rates compared to conventional chromatographic materials thereby increasing process efficiency.

However, it has been found that, with certain chromatographic media assembly types, not all the liquid passes through the chromatographic membrane mounted within the receptacle. This is due to poor sealing between the membrane and the receptacle wall. The passage of liquid around the periphery of the chromatographic membrane means that not all the target components bind to the membrane resulting in recovered material losses in relation to the volume of liquid supplied, and so reduces overall efficiency.

Conventionally, a chromatographic membrane may be ultrasonically or thermally bonded in position within the receptacle to prevent liquid from circumventing or bypassing the membrane. However, non-thermoplastic membranes cannot be sealed or bonded to the receptacle in this way and so the problem of liquid bypassing the chromatographic membrane remains an issue. This problem is particularly exacerbated when newer materials are used for the chromatographic membrane, such as cellulosic nanofibers.

According to the present invention, there is provided a receptacle for the chromatographic purification of one or more target components contained in a liquid, the receptacle comprising a seat and a chromatographic media assembly including a chromatographic membrane to which the target components will bind, and a retaining member configured to compress a portion of the chromatographic membrane between the retaining member and the seat.

The retaining member may be formed from a resiliently deformable material and can be friction fitted into the receptacle.

The chromatographic media assembly may further comprise a compression spacer element in contact with a portion of the chromatographic membrane such that the retaining member directly or indirectly engages the compression spacer element to compress the chromatographic membrane against the seat. Another compression spacer element may be in contact with an opposing surface of the portion of the chromatographic membrane facing the seat, although the periphery of the chromatographic membrane may also be in direct contact with the seat.

The chromatographic media assembly may comprise a single chromatographic membrane. Alternatively, the chromatographic media assembly may comprise a plurality of chromatographic membranes, in which case the assembly further comprises a compression spacer element interspaced between each chromatographic membrane so that the membranes are spaced from each other.

Whether the assembly includes one membrane or multiple membranes, a compression spacer element may be positioned above the uppermost membrane and/or below the lowermost membrane.

The chromatographic media assembly may comprise a first porous membrane support between the single membrane, or the uppermost membrane, and a portion of the retaining member. The first porous membrane support may be received in a recess in the retaining member.

The chromatography assembly may also comprise a second porous membrane support between the single membrane, or the lowermost membrane, and a portion of the receptacle. The second porous membrane support may be received in a recess in the receptacle formed radially inward from the seat.

The, or each, membrane may be formed from a fibrous material derivatised with groups capable of interacting with the target components. In particular, the or each membrane may be formed from a nanofibre material. In particular, the or each membrane may be formed from an electrospun hybrid nanofibre felt that may be made from derivatized cellulose and non-cellulose based polymers. Membrane derivatisiation with groups capable of interacting with the target component(s) may be performed prior to or after fitment into the receptacle. Suitable groups for use in derivatisation include but are not limited to ion-exchange groups, polar groups, chelating groups, hydrophobic groups, hydrogen-bonding groups, mixed-mode groups or affinity ligands.

The receptacle may comprise a cylindrical portion defining a first opening at one end, and a conical portion at said opposite end that tapers to a second opening. The chromatographic media assembly may be located in the cylindrical portion.

The conical portion can comprise ridges defining liquid flow distribution channels between the ridges in a direction between the cylindrical portion and the second opening. The chromatographic media assembly may be located above the ridges and may or may not lie in contact with an upper surface of the ridges.

The second opening may comprise a fitting for attachment of a liquid conduit to enable liquid to flow into, or out of, the receptacle through the second opening.

The fitting may comprise a locking element for connection of the liquid conduit to the receptacle. The lock may be a luer-lock. Alternatively, the lock may comprise a threaded connection or any other convenient means of connecting a liquid conduit to the receptacle.

In some embodiments, the receptacle may comprise a closure removably mountable to the cylindrical portion to close the first opening. The closure may provide an impermeable sealed cap or a vented cap.

The closure may comprise a conduit or tube defining a passage to enable a sample liquid to flow through the closure.

The closure tube may incorporate a fitting comprising a locking element for connection of a liquid conduit to the closure. The lock may be a luer-lock. Alternatively, the lock may comprise a threaded connection or any other convenient means of connecting a liquid conduit to the enclosure. This feature facilitates use of the receptacle in bi-directional fluid flow mode. In other words, fluid can be pumped into the receptacle through the tube or pumped out from the receptacle through the tube.

The closure may comprise a body portion that is received within the first opening in the cylindrical portion and a head portion that engages with an end of the cylindrical portion.

The closure can be a push-fit in the cylindrical portion.

The closure may comprise a resilient sealing member that locates between the body portion and the cylindrical portion to retain the body portion within the first opening.

According to one aspect of the invention, there is provided a chromatographic purification system comprising a receptacle according to the invention and a centrifuge tube into which the receptacle is inserted. Sample liquid containing the target component(s) is placed into the receptacle and fluid flow through the chromatographic membrane is achieved by the application of centrifugal force using a centrifuge apparatus. It will be obvious to one skilled in the art that sample liquid, wash buffer and elution solution may also be passed through the chromatographic membrane using this method.

According to another aspect of the invention, there is provided a chromatographic purification system comprising a receptacle according to the invention, a fluid container comprising a fluid conduit for attachment to one of said openings in the receptacle, and apparatus for generating a continuous flow of fluid from the sample fluid container through the receptacle.

The chromatographic purification system may comprise a sample fluid collector comprising a fluid conduit for attachment to the other of said openings in the receptacle to receive fluid flowing out of the receptacle.

The apparatus for generating a continuous flow of fluid may comprise a fluid pump.

The fluid conduit of the fluid container and the fluid conduit of the fluid collector may each comprise fittings for connection to complimentary fitting on the receptacle.

According to another aspect of the invention, there is provided a method of separating target components from a liquid containing target components and non-target components, the method comprising the steps of:
providing a fluid container containing a source of the sample liquid;
supplying the liquid from the container into a receptacle comprising a chromatographic media assembly including a chromatographic membrane capable of binding to the target components such that the target components are adsorbed and liquid passes through the chromatographic membrane thereby removing non-bound impurities.

The step of supplying the liquid from the container into the receptacle may comprise supplying it on a continuous basis so that the liquid flows into, and through, the receptacle.

The receptacle may comprise a cylindrical portion defining a first opening at one end, and a conical portion at said opposite end that tapers to a second opening. The method may comprise supplying the liquid on a continuous basis into the receptacle through the first or second opening.

The receptacle may comprise a closure removably mountable in the cylindrical portion to close the first opening. The closure can comprise a conduit connector and a tube for the flow of liquid through the closure. The method may comprise the step of supplying liquid on a continuous basis so that it flows through the tube in the closure.

The step of supplying liquid so that it continuously flows through the receptacle comprises supplying it into the receptacle through the second opening so that it exits the receptacle through the first opening in the tube in the closure.

According to another aspect of the invention, there is provided a chromatographic purification method to isolate a specific target component from a sample liquid containing target components and non-target components comprising:
separating the target components from the sample liquid in a separation step by:
providing a source of the liquid;
supplying the liquid from the source into a receptacle comprising a chromatographic media assembly including chromatographic membrane capable of binding to the target components such that the liquid and impurities pass through the chromatographic membrane and target components bind thereto,
further comprising removal of any impurities bound to the chromatographic membrane in a wash step by:
   supplying a wash buffer into the receptacle;
   forcing the wash buffer through the chromatographic membrane, and
   further comprising eluting the specific target component bound to the chromatographic membrane in the separation step by:
   supplying an elution solution into the receptacle;
   forcing the elution solution through the chromatographic membrane.

The step of forcing the wash buffer through the chromatographic membrane may comprise placing the receptacle into a centrifuge apparatus and operating the centrifuge apparatus. Alternatively, the receptacle may be connected to a pump and the wash buffer may be pumped through the chromatographic membrane.

The step of forcing the elution solution through the chromatographic membrane may comprise placing the receptacle into a centrifuge apparatus and operating the centrifuge apparatus. Alternatively, the receptacle may be connected to a pump and the elution solution may be pumped through the chromatographic membrane.

The separation step may comprise supplying the liquid into the receptacle so that it flows through the chromatographic membrane in a first direction.

The separation step may comprise supplying the liquid into the receptacle so that it continuously flows into, and out of, the receptacle in the first direction.

The receptacle may have first and second openings with the chromatographic media assembly located therebetween, and the separation step can comprise supplying the liquid so that there is a constant flow into, and out of, the receptacle via the first and second openings.

The separation step can comprise connecting a fluid inlet conduit to one of said first and second openings and connecting a fluid outlet conduit to the other of said first and second openings before supplying the liquid so there is a constant flow into, and out of, the receptacle via the fluid inlet conduit and the fluid outlet conduit and first and second openings.

The washing step may comprise forcing the wash buffer through the chromatographic membrane in a direction opposite to the first direction in which the liquid is supplied into the receptacle in the separation step.

The eluting step may comprise supplying the elution solution into the receptacle and forcing it through the chromatographic membrane in a direction opposite to the first direction in which the liquid is supplied into the receptacle in the separation step.

Embodiments of the present invention will now be described, by way of example only, with reference to the following drawings, in which:

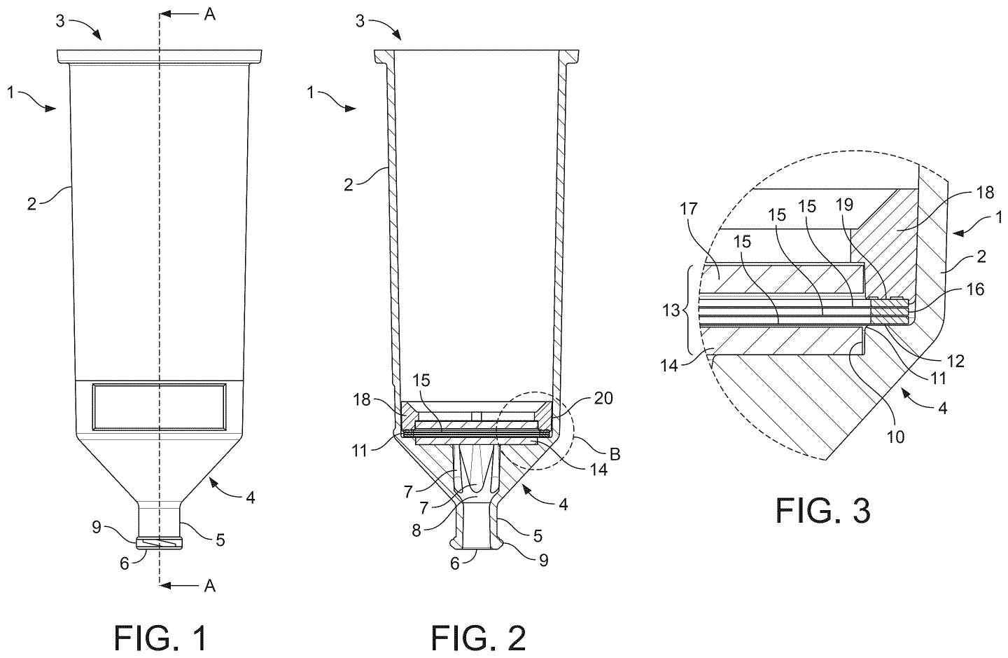

FIG. 1 illustrates a side view of a receptacle for use in a centrifuge chromatography system;

FIG. 2 illustrates a cross-sectional view of the receptacle, taken along line A-A of FIG. 1;

FIG. 3 is an enlarged view of a part of the receptacle (which is circled and marked B) shown in FIG. 2;

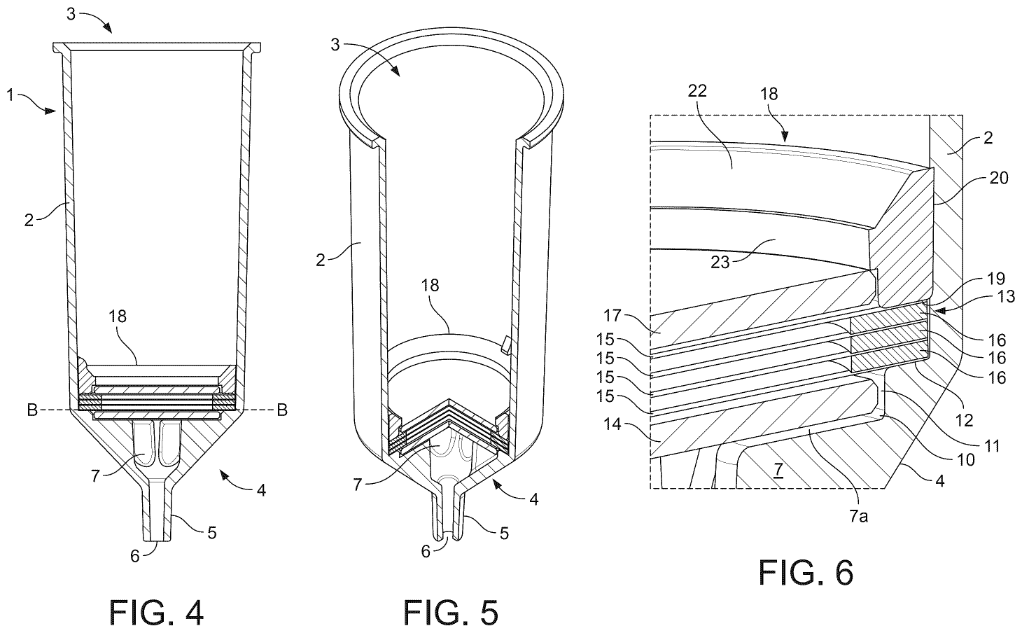

FIG. 4 illustrates another cross section through a receptacle according to an embodiment of the invention;

FIG. 5 illustrates a perspective, partially cut away, view of the receptacle of FIG. 4;

FIG. 6 is an enlarged view of a part of the receptacle shown in FIG. 4 showing the chromatographic media assembly in detail;

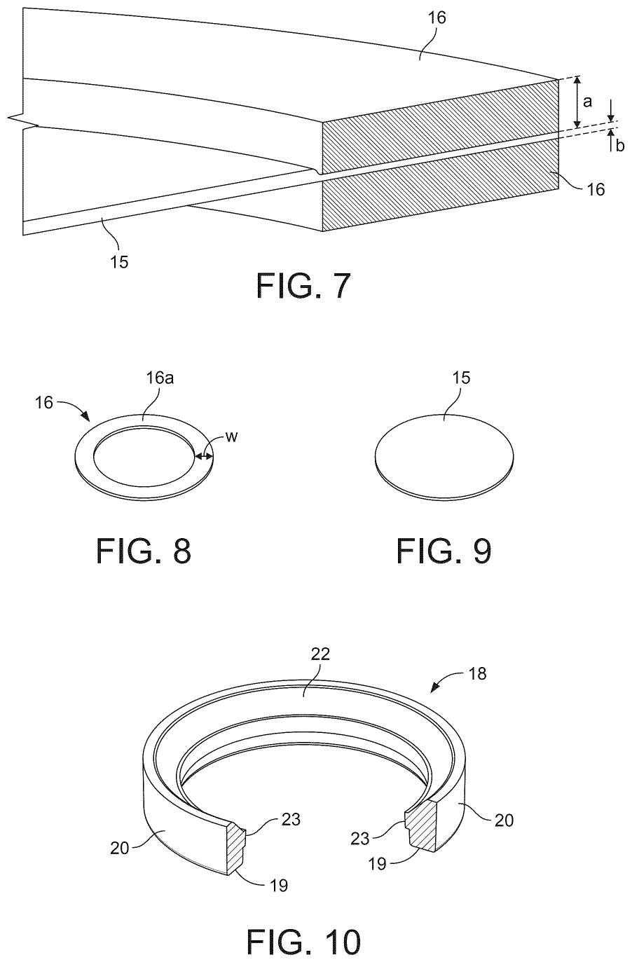

FIG. 7 shows a perspective, cross-sectional view through a portion of one chromatographic membrane and a compression spacer element on either side of the membrane and in a position in which the retaining member has compressed the periphery of the chromatographic membrane between the compression spacer elements;

FIG. 8 shows a perspective view of a compression spacer element;

FIG. 9 shows a perspective view of a chromatographic membrane;

FIG. 10 shows a perspective view of the retaining element, with a portion shown removed for clarity;

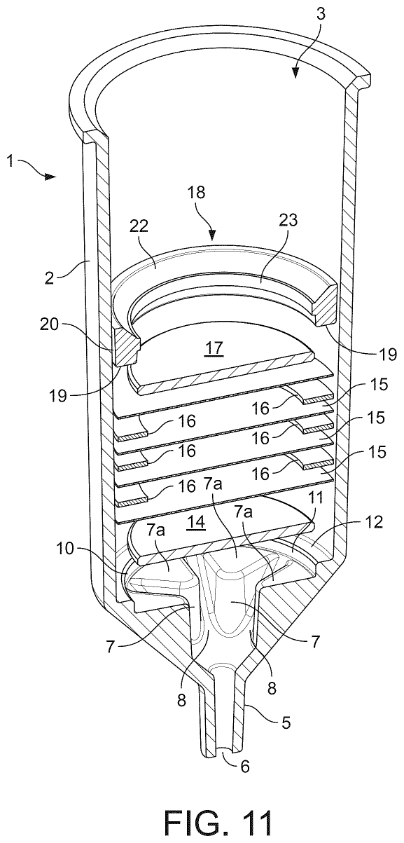

FIG. 11 is a cross-sectional perspective view of the receptacle shown in FIGS. 4 to 6, but in which the membranes, the compression spacer elements and the retaining element are shown in spaced apart or exploded form (i.e. without compression), for ease of understanding;

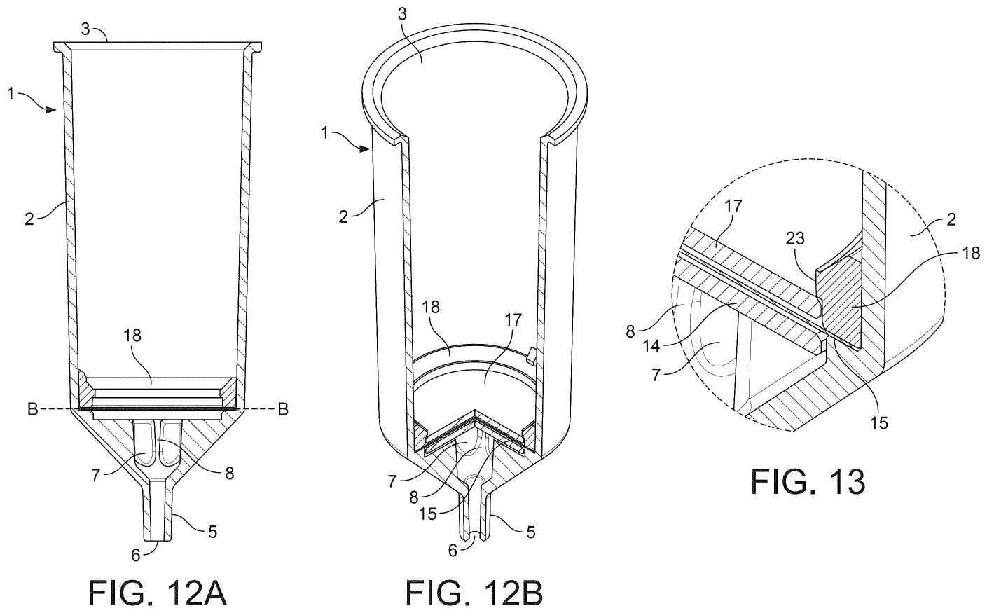

FIG. 12A is a cross-sectional view of a receptacle according to another embodiment that employs a single membrane;

FIG. 12B is a perspective, partially cut away, view of the receptacle of FIG. 12A;

FIG. 13 is an enlarged view of a part of the receptacle shown in FIG. 12B;

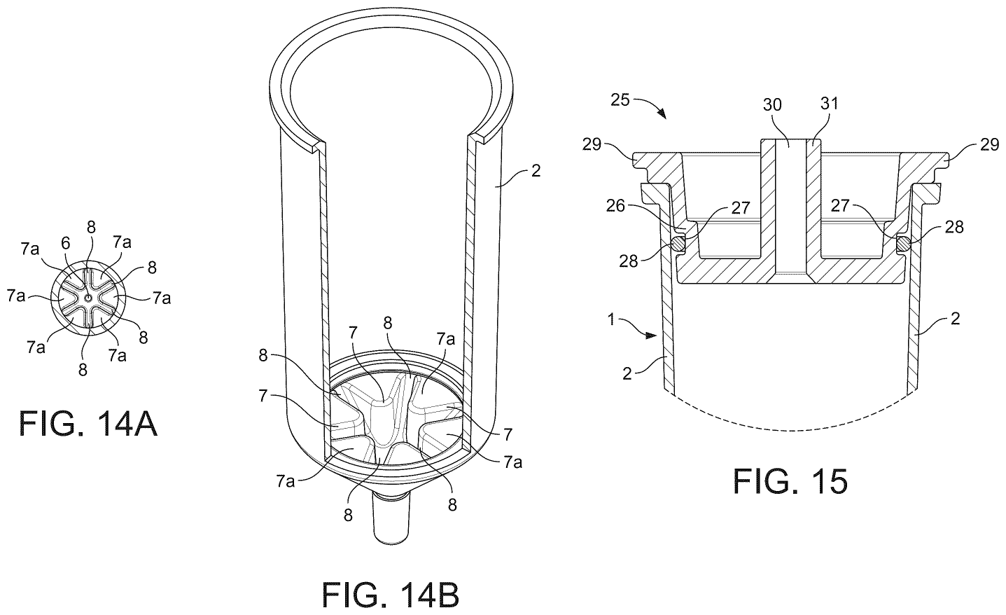

FIG. 14A is a view of a cross-section taken along the line B-B in either FIG. 4 or 12A;

FIG. 14B is a perspective, partially cut-away, view of a receptacle without a chromatographic media assembly;

FIG. 15 is a cross-sectional view of a receptacle according to any embodiment of the invention and which further includes a closure received within its upper end;

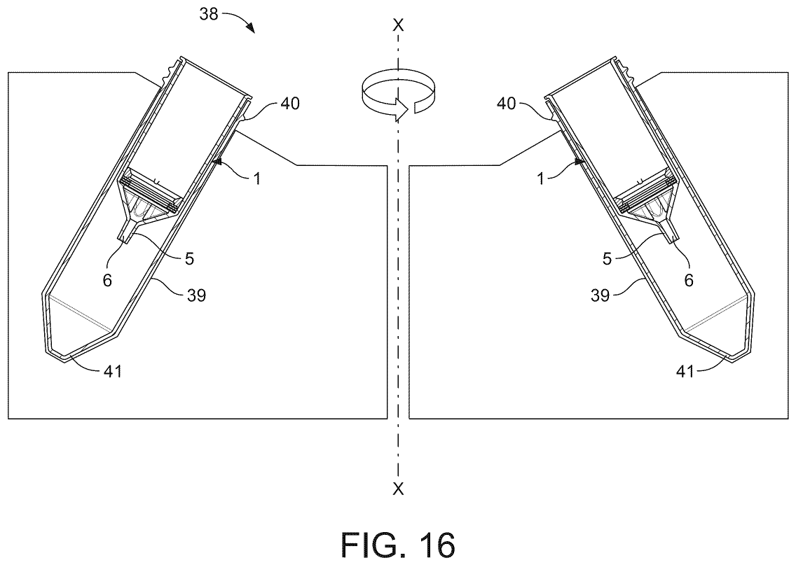

FIG. 16 illustrates two receptacles received within tubes located in a fixed-angle rotor of a centrifuge apparatus; and

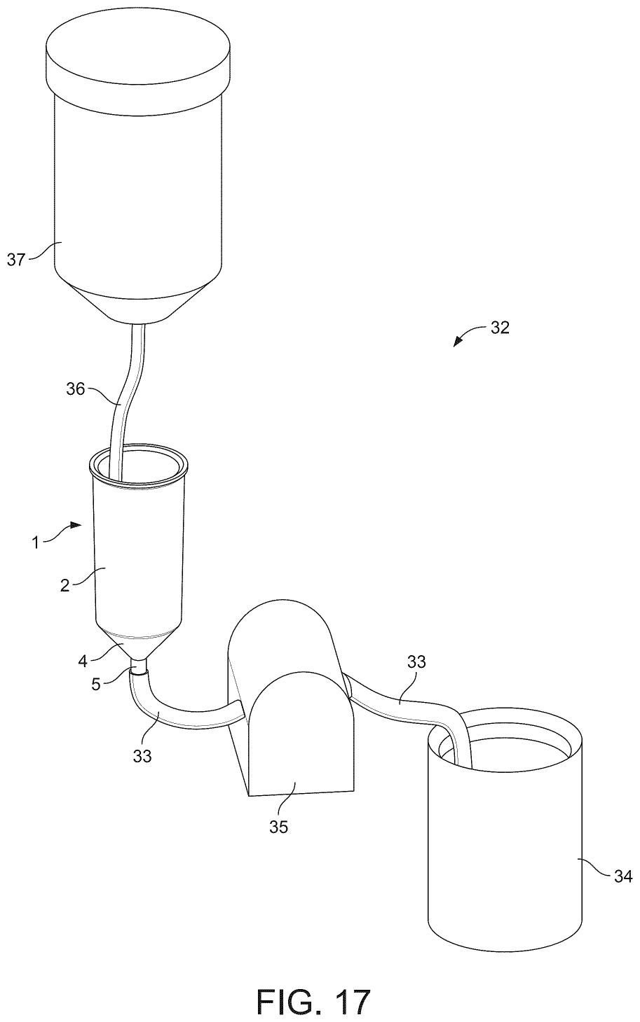

FIG. 17 illustrates an arrangement in which a pump may be used to draw fluid through the receptacle from a fluid reservoir.

With reference to FIG. 1, there is shown a receptacle 1 for use in a chromatographic purification system to receive a liquid sample that contains target and non-target components. An example of such a system is shown in FIG. 16 and will be described in more detail below.

A target component is a chemical or biological component within the sample which is to be isolated from the remaining components of the sample, so that measurements and/or other processes can be performed on that target component. The target biological component may be, for example, a protein, a glycoprotein, a lipoprotein, a protein conjugate, an antibody, a plasma protein, a protein fragment, a peptide, an amino acid, a nucleic acid, an oligonucleotide, a nucleotide, a carbohydrate, a lipid, a virus, a viral vector, a lentiviral vector (LVV), an adeno-associated virus (AAV), a measles virus, an exosome or a cell or cell particle. The target chemical component may be metal ions, radionuclides, small-molecule pharmaceuticals and associated metabolites or other organic, inorganic or synthetic chemical entities.

The receptacle 1, in the orientation shown in each of the drawings, has upper and lower ends. The receptacle 1 has an upper cylindrical portion 2 having an open end 3 at the upper end of the receptacle 1, and a lower conical portion 4 that tapers from the bottom of the cylindrical portion 2 to a lower end of the receptacle 1. A connector 5 extends from the tip of the conical portion 4 and defines an opening 6 therethrough for the flow of the liquid sample into, or out of, the receptacle 1. With reference to the cross-sectional view of FIG. 14A, which is taken along line B-B in the embodiments of FIGS. 4 and 12, and the partially cut-away perspective view of the receptacle 1 shown in FIG. 14B, the conical portion 4 contains integrally formed internal ridges 7 rising up from the inner surface of the conical portion 4 towards the cylindrical portion 2. Each ridge 7 is equally spaced from its adjacent ridge 7 to form a liquid distribution channel 8 therebetween. In the illustrated embodiments, there are six ridges 7 and so six distribution channels 8 (one between each pair of ridges 7). It will be understood that there may be more or less than six ridges 7 in other, non-illustrated, embodiments. Each distribution channel 8 extends between the top of connector 5 and the lower end of cylindrical portion 2 of the receptacle 1 along the interior wall surface of the conical portion 4. The ridges 7 have flat upper surfaces 7a. The ridges/seat structure may be a separate part securely fitted within the conical portion 4 of the receptacle 1. Alternatively, the ridges 7 and/or the seat 12 may be integrally molded into the receptacle 1 during manufacture.

The connector 5 may incorporate a fitting 9 (seen in FIGS. 1 and 2) at a its lower end remote from the conical portion 4, i.e., at the lower end of the receptacle 1 as shown in the Figures. The fitting 9 enables a liquid conduit, such as a rigid or flexible tube, such as the flexible conduit referred to below in conjunction with FIG. 16, to be engaged with the connector 5 to ensure a secure engagement. The fitting 9 may be configured to enable a liquid conduit to be positively or securely connected to, i.e. locked onto or mated with, the connector 5 so that it cannot be detached simply by pulling or as a result of pressurised flow through the conduit and connector 5. Rather, a disconnection action is required to detach one from the other. By way of example, the fitting 9 may be a luer-lock, a threaded coupling or another type of locking arrangement that will releasably connect the liquid conduit to the connector 5.

It will be appreciated that a positive connection and disconnection is not essential and that a push-fit or any other type of coupling may also be employed. However, by establishing a secure connection between a sample liquid conduit and the connector 5, liquid can be supplied into the receptacle 1 via opening 6 without the liquid conduit inadvertently becoming detached from the connector 5. It further allows liquid to be supplied or fed via opening 6 into the receptacle 1 under pressure without inadvertent detachment of the liquid conduit from the connector 5, which could potentially occur if the connection relied only on friction between the two components, such as if a more common luer-slip type connection was used. As liquid can be supplied at an elevated pressure, higher flow rates are possible.

As is most clearly visible in FIGS. 3, 6 and 11, a recess 10 is formed in the receptacle 1 proximate to the top end of the conical portion 4 of the receptacle 1 facing the inside of the cylindrical portion 2. The base of the recess 10 may be defined by upper surfaces 7a (see FIGS. 6, 11 and 14B) of the ridges 7 between which are formed the distribution channels 8 in the conical portion 4, as described above. A shoulder 11 facing towards the longitudinal axis of the receptacle 1 defines an edge or wall of the recess 10, and an upper face of the shoulder 11 forms a peripheral support or seat 12 that faces toward the upper end of the receptacle 1.

A chromatographic media assembly 13 is received in the receptacle 1 and comprises a lower porous support member 14 located in the recess 10 and supported on the upper surfaces 7a (see FIGS. 3, 6 and 10) of the ridges 7 such that it is surrounded by the shoulder 11. The depth of the recess 10 is at least equal to the thickness of the lower porous support member 14.

The chromatographic media assembly 13 may, in some embodiments, comprise a single membrane 15 optionally derivatised with an adsorbent coating comprising, for example, ion-exchange or hydrophobic groups, chelating groups, multi-mode ligands or affinity ligands, that adsorbs certain desired target components, as shown in FIGS. 12A, 12B and 13. However, it is envisaged that the chromatographic media assembly 13 most preferably comprises multiple membranes 15 positioned in stacked relation, as will be described with reference to FIGS. 2 to 6 and 11.

It will be appreciated that, in addition to a single membrane or multiple membranes 15, the chromatographic media assembly 13 may also comprise resin beads (not shown) positioned adjacent to or between the membranes to supplement purification.

In the single membrane embodiment, as shown in FIGS. 12A, 12B and 13, a compression spacer 16, preferably in the form of an annular ring with flat upper and lower surfaces, may be located on either side or both sides of the single membrane 15. An example of a compression spacer element 16 can be seen in FIG. 8, having flat upper and lower surfaces 16a. Therefore, a peripheral region of the upper and lower surface of the membrane 15 is in contact with the flat surface 16a of a compression spacer element 16. However, one, or both, of the compression spacer elements 16 may be omitted in such a single membrane configuration, in which case the retaining element (see below) will directly contact the upper face of the membrane 15 about its periphery, and the lower face of the membrane 15 will also be in direct contact with the seat 12 about its periphery.

If the chromatographic media assembly 13 includes a plurality of membranes 15 positioned in a stacked relationship, as shown in FIGS. 1 to 6 and 11, each membrane 15 is interspaced by a compression spacer element 16 so that each membrane 15 is spaced from an adjacent membrane 15. Additionally, a compression spacer element 16 may be located above the uppermost and/or below the lowermost membrane 15. The stack of membranes 15, together with their respective compression spacer elements 16 are, when retained in place within the receptacle 1 as shown in FIGS. 1 to 6, disposed on and are securely held in place against the seat 12 of the shoulder 11 at a location above the lower porous support member 14 (which is disposed in the recess 10). The membranes 15 extend radially outward, beyond the diameter of the lower porous support member 14, so that the peripheral edge of membranes 15 is supported by the seat 12 extending radially outward from the upper end of the shoulder 11. To provide good support and improved sealing properties, it will also be noted that the width “W” (see FIG. 8) of the compression spacer elements 16 in a radial direction is greater than the radial width of the seat 12 so that the compression spacer elements 16 extend radially inward over the recess 10 in which the lower porous support member 14 is received. The number of membranes 15 is limited only by the size of the receptacle 1.

FIG. 7 illustrates a close-up cross-sectional perspective view of a portion of the peripheral region of one membrane 15 in which the peripheral region is sandwiched between a pair of annular compression spacer elements 16. Each of the compression spacer elements 16 have a thickness which is greater than the thickness of the membrane 15. In some embodiments, each compression spacer element 16 may have a thickness of between 0.5 and 1 mm, as indicated by arrow marked “a” in FIG. 7, and the membrane 15 may have a thickness of between 0.01 and 0.4 mm, as indicated by arrow marked “b” in FIG. 7.

When the retaining element 18 (see below) is in place within the receptacle 1 so that it is pushing the chromatographic media assembly 13 against the seat 12, the peripheral region of the or each membrane(s) 15 are compressed between the compression spacer elements 16. Compression of the membranes 15 closes the pores or gaps between fibres of the chromatographic membrane(s) 15, thereby making the peripheral region of each membrane 15 impermeable or at least semi-permeable to liquid than the more central, uncompressed regions. The passage of liquid to the outer peripheral edge of the chromatographic membrane 15, and so the bypass of liquid around the outside of the membrane 15, i.e., between the peripheral edge of the membrane 15 and the inner surface of the cylindrical portion 2 of the receptacle 1, is prevented or minimised. The thickness of the combined compression spacer-membrane-compression spacer unit, as shown in FIG. 7, may be between 20% and 90% less than a compression spacer-membrane-compression spacer in the absence of any compressive forces.

An upper porous support member 17, in the form of a flat circular disc, is located above the uppermost membrane 15, or above the membrane 15 if only a sole membrane is provided. If a plurality of membranes 15 are provided, each of them may be formed from the same or different material and each may be of the same shape and size. The porous support members 14, 17 may be of a more rigid material than the material of the membranes 15 to help maintain the flat shape of the membranes 15 and prevent any deformation due to the weight or force of the liquid supplied to the receptacle 1. The or each porous support member 14, 17 may contact a respective uppermost or lowermost membrane 15, but one or both of the porous support members 14, 17 may also be spaced from its adjacent membrane 15 or make only light contact with its adjacent membrane 15.

The membrane(s) 15 are urged or pressed against the seat 12 by a retaining member 18, the shape of which is shown most clearly in the perspective cut-away view of FIG. 10, but the retaining member 18 is also shown in position within the receptacle 1 in FIGS. 2, 3, 4 to 6, 12A, 12B and 13, and is also visible in the exploded view of FIG. 11.

The retaining member 18 is preferably in the form of an annular ring, that is received in the cylindrical portion 2 of the receptacle 1. The retaining member 18 has a downward pressure engaging face 19 that contacts the membrane 15, or the uppermost membrane 15 if there are a plurality of membranes 15. The pressure engaging face 19 may be in direct contact with the membrane(s) 15 or it may apply pressure to the membrane(s) 15 via a compression spacer element 16 received between the uppermost membrane 15 and the retaining member 18. The pressure engaging face 19 may include notches or feet (not shown) that act to enhance the retention of the membrane(s) 15, particularly when a single membrane 15 is used. Alternatively, the pressure engaging face 19 may be smooth and contact the compression spacer element 16 or membrane 15 about its entire circumference. The retaining member 18 also has an outer surface 20 that faces the inside of the cylindrical portion 2 and contacts its cylindrical inner surface.

The retaining member 18 is resiliently deformable and is sized and dimensioned so that it is a press fit, a friction fit or at least a relatively tight sliding fit within the cylindrical portion 2 with its surface 20 in engagement with the wall of the cylindrical portion 2. The inner wall of the cylindrical portion 2 of the receptacle 1 is generally smooth, but the surface may be provided with a certain roughness to increase friction between the inner surface of the cylindrical portion 2 and the outer surface 20 of the retaining member 18.

An upper surface 22 of the retaining member 18 is chamfered in a direction that extends downwardly and away from the inner surface of the cylindrical portion 2 of the receptacle 1 towards the upper porous support member 14. The chamfered surface 22 helps to direct liquid away from the inner surface of the cylindrical portion 2 and towards a more central portion of the chromatographic membrane(s) 15.

The retaining member 18 can be formed of any resiliently deformable material, such as an elastomeric material, and is pushed down the cylindrical portion 2 from the opening 3 in the upper end of the cylindrical portion 2 with its surface 20 sliding against the inner surface of the cylindrical portion 2 until it contacts the uppermost membrane 15 or compression spacer element 16. Further urging of the retaining member 18 into the cylindrical portion 2 causes the retaining member to apply pressure to the membrane(s) 15 and any compression spacer elements 16 to push them against the seat 12. Friction between the retaining member 18 and the inner surface of the cylindrical portion 2 holds the retaining member 18 in place. Further, the pressure of the retaining member 18 against the membrane(s) 15 and the compression spacer elements 16 holds the chromatographic media assembly 13 in place, presses the assembly 13 down against the seat 12 and prevents the assembly from becoming dislodged.

The retaining member 18 (as shown most clearly in FIGS. 2, 3, 6, 10 and 11) may have a radially inwardly extending lip 23 spaced from the pressure engaging face 19, that forms a recess to receive and retain the the upper porous support member 14 between the radially inwardly extending lip 23 and the pressure engaging face 19. Therefore, the retaining member 18 also positions the upper porous support member 17 and holds it in place within the recess. The retaining member 18 squeezes the membrane(s) 15 and compression spacer elements 16 together between the pressure engaging face 19 of the retaining member 18 and the seat 12 of the receptacle. The retaining member 18 supports the membrane or membranes 15 within the receptacle 1 thereby preventing movement of the membranes 15 that could affect performance and/or sealing.

Furthermore, and as described above, the combined compression spacer elements 16 and the membranes 15 are squeezed and compressed between the retaining member 18 and the seat 12 so that any spaces or pores between the fibres in the peripheral region of the membrane 15 between the compression spacer elements 16 are closed or semi-closed so that liquid is prevented or restricted from flowing radially towards the peripheral edge of the membrane 15. By preventing liquid from travelling radially outward to the peripheral edge of the membranes 15, bypass of liquid around the outside of the membranes 15 is prevented.

FIG. 15 shows a portion of the upper end of a receptacle 1 according to any of the previously described embodiments. In this embodiment, the receptacle 1 is additionally provided with a closure 25, a portion of which is received in the open upper end of the cylindrical portion 2. The closure 25 includes a body portion 26 incorporating a channel 27 in which a sealing element 28 is received, such as an elastomeric O-ring. In other, unillustrated, embodiments, a raised protrusion of polypropylene connected to or associated with the closure 25 may be provided to provide a seal between the closure 25 and the receptacle 1.

The body portion 26 of the closure 25 may be sized and adapted to be push fit into the cylindrical portion 2 of the receptacle 1 so that a head portion 29, with a diameter larger than that of the body portion 26, seats against an end face of the cylindrical portion 2 of the receptacle 1 and acts to stop further movement of the closure 25 into the cylindrical portion 2 of the receptacle 1.

The closure 25 includes a passage 30 defined by a passage wall 31 such as a cylindrical or other shaped tube, that allows liquid to flow through the closure 25 into, or out of, the receptacle 1. A liquid conduit may be connected to the closure 25 at the opening of the passage 30 to enable fluid to pass between the conduit and the passage 30 and through the closure 25. Once a liquid conduit is connected to the passage 30 of the closure 25, the receptacle 1 is closed to the atmosphere. In other embodiments, the closure can be a plain cap or a vented cap to allow air to pass and balance the internal pressure of the receptacle during centrifugation and associated reduction of liquid volume.

It will be understood that the closure 25 can be attached to the receptacle 1 in ways other than by push-fit. For example, the closure 25 and the receptacle 1 could have complimentary threaded connections to allow the closure 25 to be screwed onto the receptacle 1. The opening of the passage 30 of the closure 25 may also be provided with a fitting similar to the connector 5 at the end of the conical portion 4 so that a liquid conduit may be securely connected to the passage wall 31 of the closure 25, i.e. a luer-lock type connection may be employed. This feature facilitates use of the receptacle 1 in bi-directional fluid flow mode. In other words, fluid can be pumped into the receptacle 1 through the passage 30 or pumped out from the receptacle 1 through the passage 30.

When in use, a liquid sample containing target and non-target components is supplied into the receptacle 1 so that it flows through a portion of the chromatographic media assembly 13. The membrane(s) 15 optionally have, or are derivatised with an adsorbent coating comprising, for example, ion-exchange or hydrophobic groups, chelating groups, multi-mode ligands or affinity ligands, that adsorbs certain desired target components so that those target components bind to the adsorbent.

A chromatographic media purification system 32, according to one embodiment, is shown in FIG. 17. A first liquid conduit 33, which may be a flexible tube, has one end attached to the connector 5 and leads to a collection container 34 via a pump 35. A second liquid conduit 36, which may be flexible tube, has one end connected to a reservoir 37 containing a supply of liquid, and the other end connected to the upper end of the cylindrical portion 2 of the receptacle 1, via a closure, such as closure 25 shown in FIG. 15 (but which is not shown in FIG. 17). This arrangement allows liquid to flow from the reservoir 37 along the second liquid conduit into the receptacle 1, through the membranes 15 of the chromatography media assembly 13, and out of the receptacle 1 through the first liquid conduit 33 and into the collection container 34 in a continuous manner, in response to operation of the pump 35. In this way, the separation of target components from a quantity of liquid that has a much greater volume than the volume of the receptacle 1 is enabled. This is particularly advantageous where there is a large volume of liquid that contains a relatively low quantity of target component.

Although the pump 35 is positioned to draw fluid from the reservoir 37 through the receptacle 1, the pump 35 may alternatively be positioned in the second liquid conduit 36 to push fluid through the receptacle 1.

The liquid sample can be made to flow through the receptacle 1 in either direction. For example, liquid can be supplied into the receptacle 1 through the opening 6 in the connector 5, and to exit the receptacle 1 through the passage 30 in the closure 25, or into the receptacle 1 through the passage 30 in the closure 25 received in the upper end of the cylindrical portion 2 so that it exits the receptacle 1 through the opening 6 in the connector 5. By allowing sample fluid to flow into the receptacle 1 via the opening 6 in the connector 5, it flows along the distribution channels 8 between the ridges 7 in the conical portion 4 and may be distributed more evenly before it flows through the single membrane 15 or multiple membranes 15 of the chromatographic media assembly 13.

The system 32 may incorporate a control unit (not shown) to enable a user to control the rate of flow of liquid through the receptacle 1. The liquid collected in the collection container 34 may be disposed of. Instead of a collection container 34, liquid conduit 33 may simply discharge to waste, such as a drain.

Once the initial separation or capture step has been completed, a wash step may be performed in which a wash buffer is supplied into the receptacle 1 to further purify a specific target component from all the target components bound to the membrane(s) 15. It is envisaged that the wash buffer will be supplied into the receptacle 1 in the same direction to the direction in which the liquid flows during the separation step referred to above, although it may be supplied into the receptacle 1 in the opposite direction. The wash step may involve detaching any liquid conduits 33, 36 from the receptacle 1 and placing the receptacle 1 in a centrifuge 38 (see FIG. 16) so that centrifugal force is applied to push or force the wash buffer through the membrane(s) 15.

FIG. 16 shows, in simplified form, a centrifuge apparatus 38 having pockets 39 (two shown in FIG. 16) to receive centrifuge tubes 40 having closed lower ends 41. A receptacle 1 is slidably received in the upper, open end of each centrifuge tube 40. When the receptacles 1 are subjected to centrifugal force, as a result of spinning the centrifuge apparatus 38 about axis X-X, the wash buffer placed in the receptacles 1 will be forced through the membrane(s) 15 and out through the connector 5 so that it collects within the closed lower ends 41 of the centrifuge tubes 40.

It will be understood that the wash buffer may forced through the membrane(s) 15 in other ways, such as by using a pump.

The wash buffer is selected so that impurities are released into the wash buffer to leave one or more target components bound to the membrane 15. The wash step may be performed one or more times with the same or different wash buffers to release different target components to isolate and leave a specific target component still bound to the membrane 15. By ensuring that the wash buffer is allowed to flow through the receptacle 1 in a direction opposite to the flow of the liquid sample through the receptacle 1 during the separation stage, the unwanted components, particularly unwanted particulate impurities are more easily released from the membrane 15 to leave target components of interest remaining on the membrane 15.

A final elution step may then be performed by introducing an elution solution into the receptacle 1 which acts to elute the desired target components from the membranes 15. As with the wash step, receptacle 1 is placed in a centrifuge and the specific target component is eluted, with the aid of the elution solution, from the membranes 15 with application of centrifugal force, in the same way as described above and using a centrifuge apparatus 32 as described in relation to FIG. 16. The elution solution is preferably introduced into the receptacle 1 so as to allow it to flow through the receptacle 1 in the same direction as the wash buffer, i.e. in the direction opposite to the flow of liquid sample through the receptacle 1 during the separation stage.

It will be appreciated that, rather than use a centrifuge, the elution solution may be forced through the membrane(s) in other ways, such as by using a pump.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A receptacle for the chromatographic purification of a one or more target components contained in a liquid, the receptacle comprising:
a seat and a chromatographic media assembly including at least one chromatographic membrane to which the target components bind, and
a retaining member configured to compress a portion of the at least one chromatographic membrane between the retaining member and the seat.

2. A receptacle according to claim 1, wherein the retaining member is formed from a resiliently deformable material and is friction fitted into the receptacle.

3. A receptacle according to claim 2, wherein the chromatographic media assembly further comprises a compression spacer element in contact with a portion of the chromatographic membrane such that the retaining member directly or indirectly engages the compression spacer element to compress the chromatographic membrane against the seat.

4. A receptacle according to claim 3, comprising a further compression spacer element in contact with an opposing surface of the portion of the chromatographic membrane facing the seat.

5. A receptacle according to claim 1, wherein the chromatographic media assembly comprises a single chromatographic membrane.

6. A receptacle according to claim 1, wherein the chromatographic media assembly comprises a plurality of chromatographic membranes, and the assembly comprises a compression spacer element interspaced between each e chromatographic membrane. so that the chromatographic membranes are spaced from each other.

7. A receptacle according to claim 1, wherein the chromatographic media assembly comprises a first porous membrane support between the single membrane, or the uppermost membrane, and a portion of the retaining member.

8. A receptacle according to claim 7, wherein the retaining member comprises a recess, and the first porous membrane support is received in said recess.

9. A receptacle according to claim 8, comprising a second porous membrane support between the single membrane, or the lowermost membrane, and a portion of the receptacle.

10. A receptacle according to claim 9, comprising a recess in the receptacle formed radially inward from the seat, wherein the second membrane support is received in said recess.

11. A receptacle according to claim 1, wherein the or each membrane is formed from a fibrous material derivatised with groups capable of interacting with the target components.

12. A receptacle according to claim 11, wherein the or each membrane is made from a material comprising nanofibers, such as an electrospun hybrid nanofiber felt made from derivatized cellulose and non-cellulose based polymers.

13. A receptacle according to claim 1, comprising a cylindrical portion defining a first opening at one end, and a conical portion at said opposite end that tapers to a second opening, the chromatographic media assembly being located in the cylindrical portion.

14. A receptacle according to claim 13, wherein the conical portion comprises ridges defining liquid flow distribution channels between the ridges in a direction between the cylindrical portion and the second opening.

15. A receptacle according to claim 14, wherein the chromatographic media assembly is located above the ridges.

16. A receptacle according to claim 13, wherein the second opening comprises a fitting for attachment of a liquid conduit to enable liquid to flow into, or out of, the receptacle through the second opening.

17. A receptacle according to claim 16, wherein the fitting comprises a locking element for connection of the liquid conduit to the receptacle.

18-19. (canceled)

20. A receptacle according to claim 13, comprising a closure removably mountable to the cylindrical portion to close the first opening.

21. A receptacle according to claim 20, wherein the closure comprises a tube defining a passage to enable a sample liquid to flow through the closure.

22. A receptacle according to claim 21, wherein the tube incorporates a fitting comprising a locking element for connection of a liquid conduit to the closure.

23. (canceled).

24. A receptacle according to 20, wherein the closure comprises a body portion that is received within the first opening in the cylindrical portion and a head portion that engages with an end of the cylindrical portion.

25-46. (canceled)
